(19) United States
(12) Patent Application Publication
(10) Pub. No.: US 2013/0036140 A1
(43) Pub. Date: Feb. 7, 2013

(54) INFORMATION MANAGEMENT AND CONTINUITY

(71) Applicant: Robert David Bowes, San Jose, CA (US)

(72) Inventor: Robert David Bowes, San Jose, CA (US)

(73) Assignee: LWD TECHNOLOGY, INC., San Jose, CA (US)

(21) Appl. No.: 13/564,024

(22) Filed: Aug. 1, 2012

Related U.S. Application Data
(60) Provisional application No. 61/514,183, filed on Aug. 2, 2011.

(51) Int. Cl. G06F 17/30

(52) U.S. Cl. 707/781; 707/E17.005

(57) ABSTRACT

Embodiments of the invention provide methods, systems, and program products for managing information, including the incremental release of information from a restricted database of information, such that the incremental release is consistent with relationships between and among a plurality of pieces of information within the restricted database.

### CROSS-REFERENCE TO RELATED APPLICATIONS

This application claims the benefit of co-pending U.S. Provisional Patent Application No. 61/514,183, filed 2 Aug. 2011, which is hereby incorporated herein.

### BACKGROUND

Managing information and ensuring its continuity becomes increasingly complex as the amount of information and the relationships between and among pieces of information increase. Although applicable to the management and continuity of all information, this problem is often encountered in creative environments, such as novel writing, script writing, role playing games, video game development, etc., where the relationships between and among pieces of information are seldom all pre-defined and generally evolve organically over time.

In creative endeavors such as these, the creator(s) often develop a “world bible” that progressively builds up information about the environment and can be used both to flesh out the environment during its creation and to ensure the continuity of its information. Managing such information manually, such as in hardcopy, can quickly become unworkable. Other methods, such as the use of wiki pages, allows a user to link pieces of information in a database. However, the management of a wiki requires a high level of technical ability. In addition, the linking of wiki pages is not done visually, which would offer a considerable advantage to creative individuals.

### SUMMARY OF THE INVENTION

In one embodiment, the invention provides a method of incrementally disclosing information from a restricted database of information, the method comprising: accessing a restricted database of information containing: a first piece of information; and a second piece of information related to the first piece of information; releasing from the restricted database the first piece of information; and releasing from the restricted database the second piece of information consistent with the relationship between the second piece of information and the first piece of information.

In another embodiment, the invention provides a system comprising: at least one computing device configured for incrementally disclosing information from a restricted database of information by performing a method comprising: accessing a restricted database of information containing: a first piece of information; and a second piece of information related to the first piece of information; releasing from the restricted database the first piece of information; and releasing from the restricted database the second piece of information consistent with the relationship between the second piece of information and the first piece of information.

In still another embodiment, the invention provides a program product stored on a computer-readable storage medium which, when executed, is operable to incrementally disclose information from a restricted database of information by performing a method comprising: accessing a restricted database of information containing: a first piece of information; and a second piece of information related to the first piece of information; releasing from the restricted database the first piece of information; and releasing from the restricted database the second piece of information consistent with the relationship between the second piece of information and the first piece of information.

In some embodiments of the invention, the second piece of information could itself be a relationship that exists between two pieces of information.

In yet another embodiment, the invention provides a method of managing information, the method comprising: accessing a work containing a plurality of pieces of information; deriving from the work a first piece of information and a second piece of information; defining a relationship between the first piece of information and the second piece of information, whereby use of either or both of the first piece of information and the second piece of information is consistent with the defined relationship between the first piece of information and the second piece of information.

In another embodiment, the invention provides a system comprising: at least one computing device configured for managing information by performing a method comprising: accessing a work containing a plurality of pieces of information; deriving from the work a first piece of information and a second piece of information; defining a relationship between the first piece of information and the second piece of information, whereby use of either or both of the first piece of information and the second piece of information is consistent with the defined relationship between the first piece of information and the second piece of information.

In yet still another embodiment, the invention provides a program product stored on a computer-readable storage medium which, when executed, is operable to manage information by performing a method comprising: accessing a work containing a plurality of pieces of information; deriving from the work a first piece of information and a second piece of information; defining a relationship between the first piece of information and the second piece of information, whereby use of either or both of the first piece of information and the second piece of information is consistent with the defined relationship between the first piece of information and the second piece of information.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-3 show a schematic of the management and incremental release of information according to various embodiments of the invention.

FIG. 4 shows a schematic of the management and incremental release of information according to another embodiment of the invention.

FIG. 5 shows a schematic of the management of information in relation to a geographic area, according to another embodiment of the invention.

FIG. 6 shows a schematic view of a graphical user interface (GUI) according to an embodiment of the invention.

FIG. 7 shows a schematic view of an illustrative system according to an embodiment of the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION

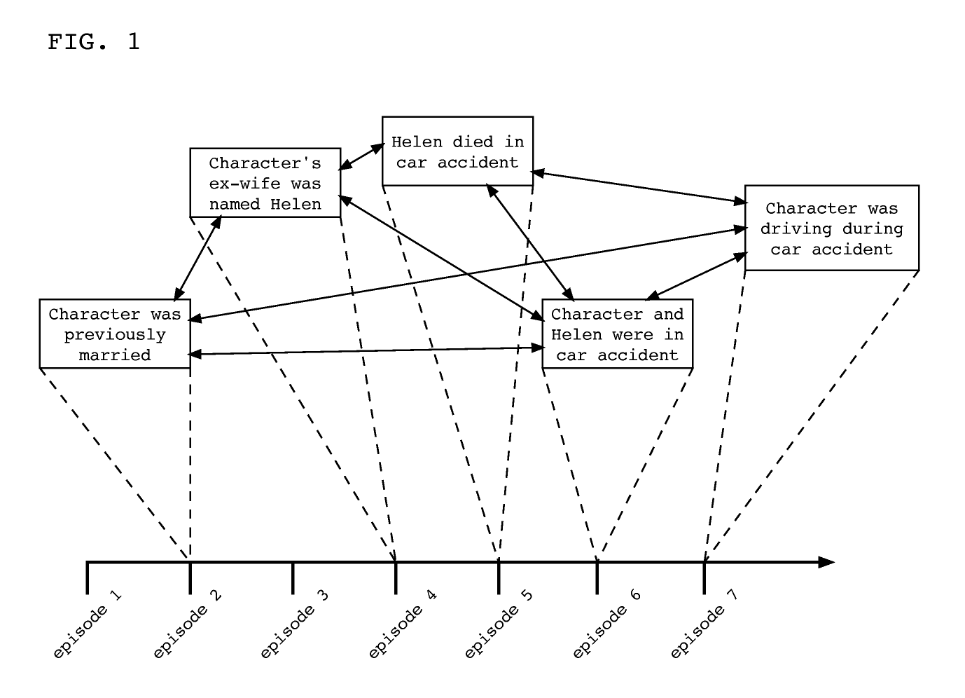

Referring now to the drawings, FIG. 1 shows a schematic representation of a plurality of pieces of information in a restricted database, relationships between and among these pieces of information, and a theoretical timeline over which the pieces of information may be incrementally revealed. As used herein, “revealed” shall mean disclosing or making available to a wider audience a piece of information that was previously unavailable or restricted to a narrower audience. In some embodiments of the invention, for example, a piece of information may be revealed by releasing the piece of information from a restricted database by either transferring the piece of information to an unrestricted or less restricted database or by changing a feature or parameter of the piece of information to make it more widely available from within the restricted database. One of ordinary skill in the art will, of course, recognize other techniques and methods for increasing the availability of such information and such other techniques and methods are within the scope of the invention.

Still referring to FIG. 1, it can be seen that the piece of information “Character was previously married” is related to three other pieces of information: “Character's ex-wife was named Helen,” “Character was driving during car accident,” and “Character and Helen were in car accident.” These three other pieces of information all relate directly to “Character” and are therefore shown as related to “Character was previously married.” These relationships may be shown in other ways, of course. For example, in some embodiments of the invention, a general piece of information, such as “Character” could be shown with relationships to all other pieces of information related to “Character” being shown as related. The method of representation in FIG. 1 is therefore illustrative and for the purpose of explanation only and is not to be viewed as limiting the scope of the invention.

The piece of information “Helen died in car accident” is not shown as directly related to “Character was previously married,” but is shown as related to the other four pieces of information, each of which relates directly to either Helen or the car accident.

In FIG. 1, it can be seen that each piece of information is incrementally released (e.g., revealed to an audience) according to a timeline. Here, the timeline is expressed in terms of episodes, such as television episodes or podcast episodes. Other expressions or units of time are possible, of course, such as book chapters, film scenes, acts of a play, levels of a video game, etc., as will be apparent to one of ordinary skill in the art.

The incremental release of information in FIG. 1 is shown as “Character was previously married,” “Character's ex-wife was named Helen,” “Helen died in car accident,” “Character and Helen were in car accident,” and “Character was driving during car accident.” This creates one narrative or story that a creator may wish to reveal to an audience. That is, the creator may wish first to introduce Character, Helen, and their relationship, without revealing until later that Helen has died in a car accident, and not until much later reveal that Character may have been responsible for Helen's death.

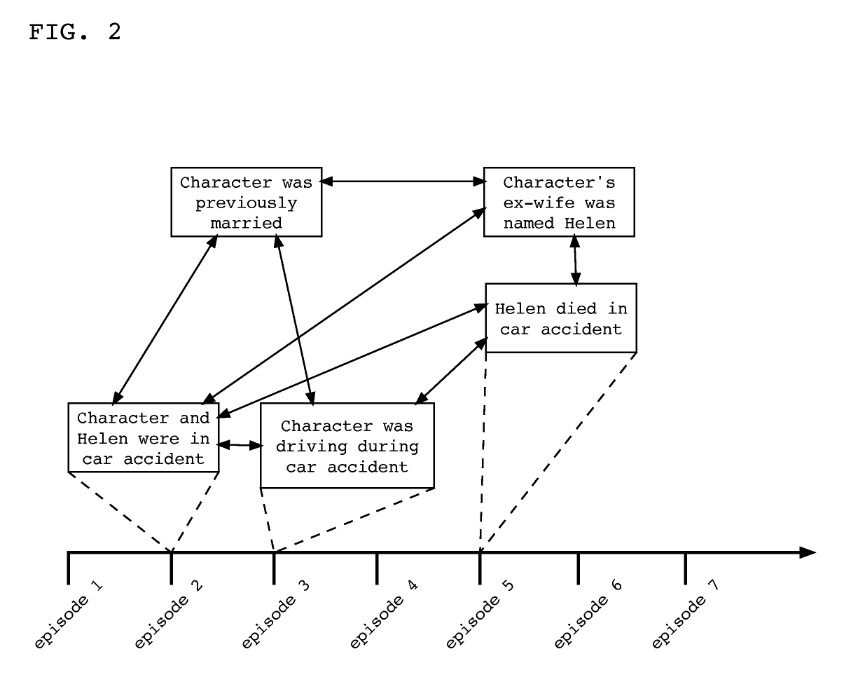

Other narratives or stories could be created using the same set of pieces of information, of course. For example, FIG. 2 shows a schematic of an alternate incremental release of information. The relationships between and among the pieces of information are the same as in FIG. 1. Here, however, the release of information is “Character and Helen were in car accident,” “Character was driving during car accident,” and “Helen died in car accident.” The narrative or story of FIG. 2 is therefore quite different from that of FIG. 1. The information that “Character was previously married” and “Character's ex-wife was named Helen” are not revealed at all.

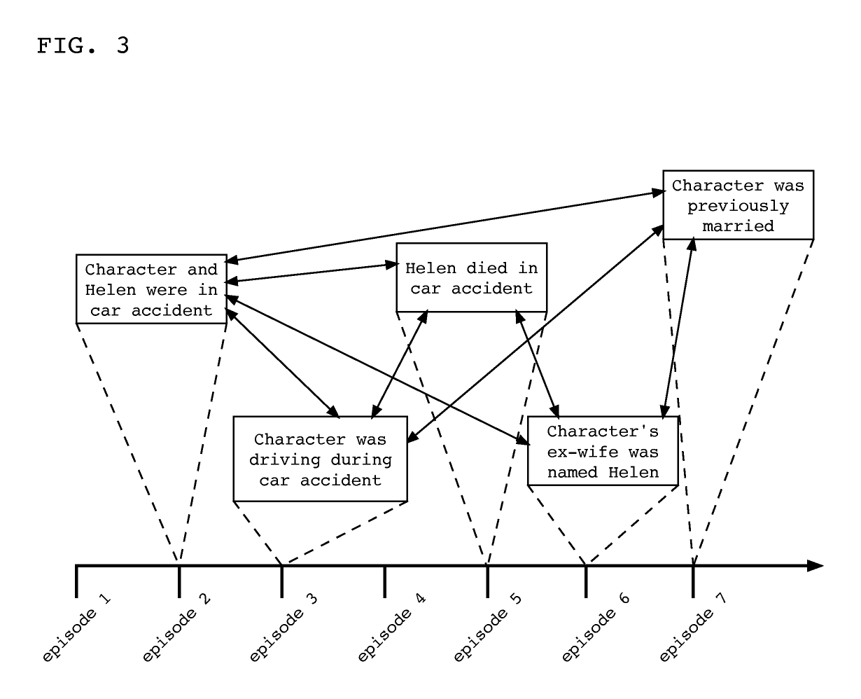

FIG. 3 shows another schematic in which the incremental release of information creates a potential discontinuity. Again, the relationships between and among the pieces of information are the same as in FIGS. 1 and 2. Here, the first three pieces of information released (“Character and Helen were in car accident,” “Character was driving during car accident,” and “Helen died in car accident”) are the same as in FIG. 2. The remaining pieces of information (“Character's ex-wife was named Helen” and “Character was previously married”) are then released, in that order.

While revealing that Character's ex-wife was named Helen may legitimately further the narrative already created by first three pieces of information revealed, the subsequent revealing that Character was previously married creates a potential discontinuity. If, for example, Character was previously married only to Helen, there is no value in releasing this last piece of information (“Character was previously married”), since it had previously been revealed that Character's ex-wife was named Helen. Worse still, revealing this information may lead an audience to believe that Character was, in fact, previously married to someone other than Helen. If this is not true, revealing this information at this point would constitute a discontinuity in the narrative.

While the timeframe shown in FIGS. 1-3 is defined in terms of episodes, this is, of course, but one example of how the incremental revelation of information may be defined and managed. The particular timeframe, as well as its granularity, will necessarily differ depending on the type of information being managed, its medium or media, and the narrative style. For example, it may be necessary or desirable, in some circumstances, to define the timeframe with greater granularity, such as by a particular scene within an episode, a page in a screenplay, or even a particular time or frame within a moving picture.

More detailed granularity may enable a creator, as he or she is working on a project, to review not just when a particular piece of information was revealed, but to review how it was revealed by, for example, referring to and reviewing the scene, frame, page, etc. at which it was revealed. This enables the creator to then amend other parts of the project, if necessary, or to ensure that subsequently created portions of the project are consistent with the revealed piece of information. According to another aspect of the invention, following an incremental release of information, such as that described above, a second, bulk release of information may be made. For example, it may be desirable, following the publication of a narrative (e.g., a television episode) to an audience, it may be desirable to release, in bulk, all of the pieces of information previously released incrementally. Such release may be made, for example, by publishing the information to a network website or a fan website.

Such subsequent, bulk releases of information may be employed for any number of reasons, including, for example, the generation of publicity, discussion, critique, etc. amongst fans, the media, critics, etc. In some cases, such subsequent, bulk releases of information may be made on a subscription or other paid basis.

The examples shown in FIGS. 1-3 are merely illustrative of how information may be incrementally revealed and the susceptibility of the process to discontinuities. Of course, information may be represented in any number of ways in the various embodiments of the invention. Similarly, the identification and avoidance of discontinuities in the incremental revelation of such information may also be presented to a user in any number of ways.

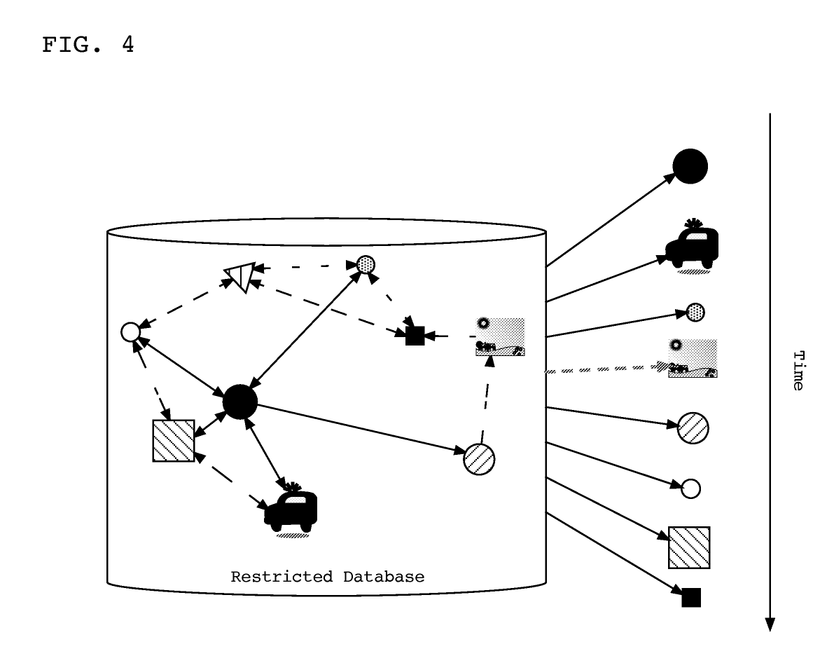

For example, FIG. 4 provides a graphical representation of various pieces of information within a restricted database of information. As can be seen, pieces of information may be represented as different shapes, patterns, colors, graphic images, video clips, photographs, etc., depending, for example, on the nature of the piece of information and/or how a piece of information is to be or may be used. Similarly, relationships between and among the pieces of information are represented by various styles of connecting lines (e.g., solid, broken). Many relationships are shown as bi-directional, indicating that a two-way relationship exists between pieces of information, such that either may be revealed prior or subsequent to revelation of the other. Other relationships are shown as uni-directional, indicating that the “upstream” piece of information must be revealed prior to the “downstream” piece of information in order to avoid a discontinuity.

In addition, FIG. 4 shows the incremental release of each piece of information from the restricted database. In some embodiments of the invention, a user may be alerted to a discontinuity in the chosen order in which the pieces of information are to be released. Specifically, it can be seen that the piece of information shown released from the restricted database with a broken arrow represents a discontinuity. That piece of information is “downstream” of only one other piece of information which, in the order chosen, has not yet been revealed.

Thus, embodiments of the invention enable management of information along multiple axes. For example, establishing a relationship between two pieces of information constitutes management along one axis, indicating a directionality (e.g., uni-directional) of the relationship constitutes management along a second axis. The incremental release of information consistent with such relationships as part of a larger narrative constitutes management along yet another axis.

Yet another aspect of the invention includes dividing the body of information that comprises the restricted database into discreet pieces of information that are suitable for individual release. In some embodiments of the invention, each discreet piece of information represents a single, atomic element of the overall narrative. One can then release an individual piece of information through a single operation, such as through the click of a mouse. By changing the order in which pieces of information are revealed, the overall narrative can take different forms, even though the underlying body of information remains unchanged.

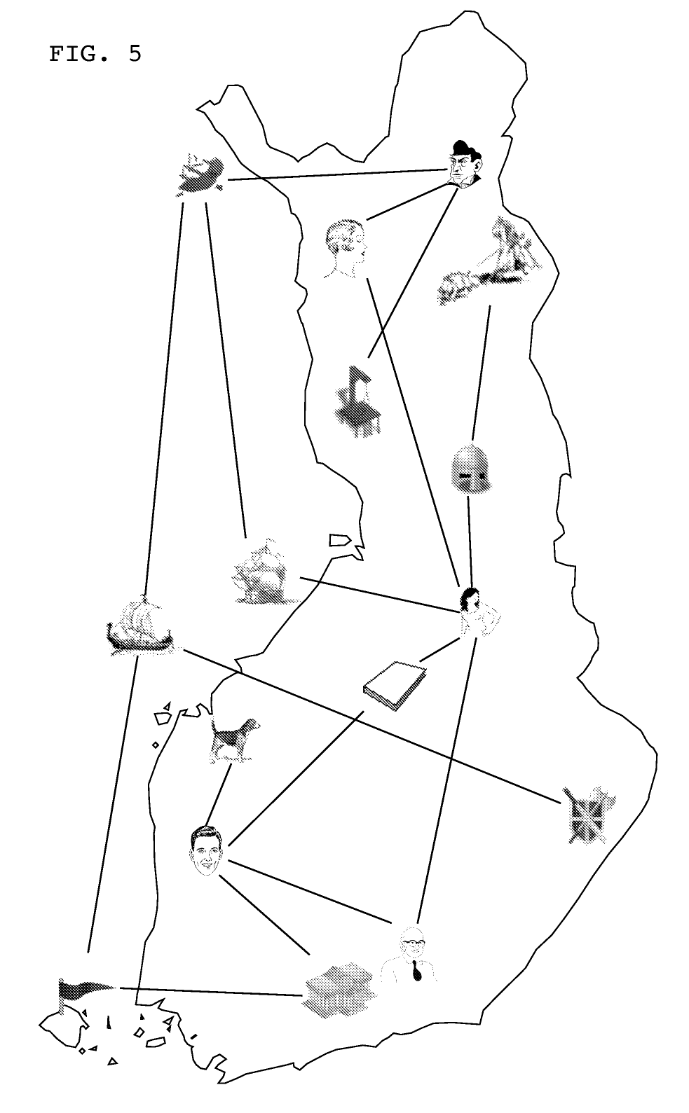

FIG. 5 shows yet another example of a manner in which information may be represented to a user, according to some embodiments of the invention. Here, pieces of information, each represented graphically, are presented not only in relation to each other, but also in relation to a map. Such embodiments may be particularly useful, for example, in creative works in which characters and events are introduced both temporally and geographically.

In some embodiments of the invention, the pieces of information incrementally revealed may relate to geographic or scenic components themselves. For example, a character may, in exploring a new environment, scene, terrain, etc., acquire information about that environment, scene, terrain, etc., in an incremental fashion. This information and its release to a user must be carefully managed to avoid discontinuities.

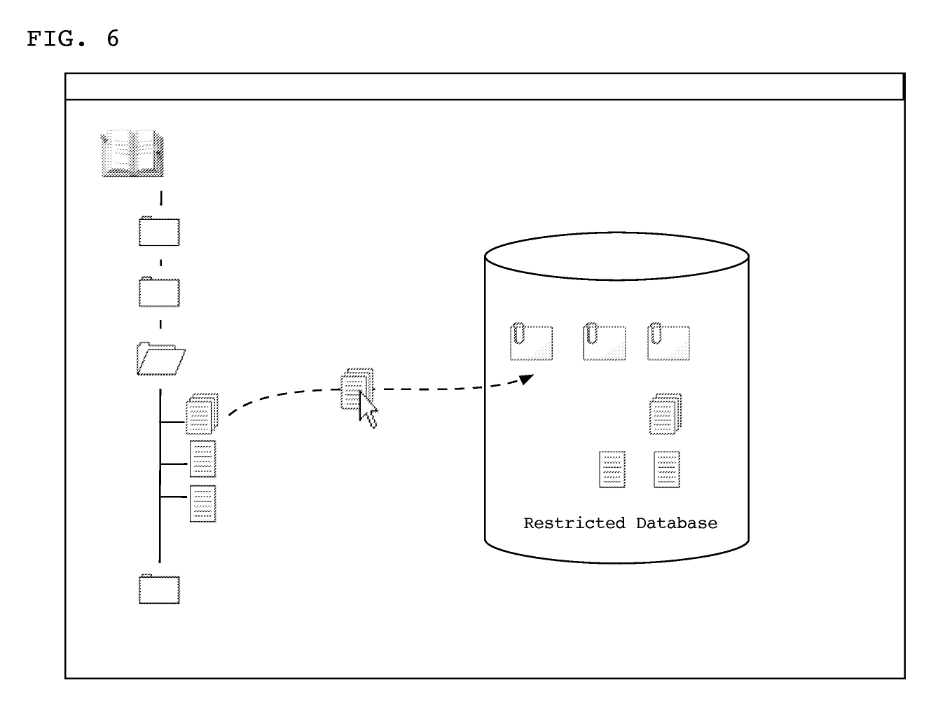

FIG. 6 shows another aspect of the invention, whereby pieces of information may be derived from a larger work and relationships between and among the derived pieces of information may be defined. In some embodiments of the invention, these derived pieces of information may be stored in a restricted database such that their release may be controlled for purposes of continuity, as described above.

In the embodiments of the invention described above, various pieces of information are assumed to exist. However, some embodiments of the invention may include a determination of what constitutes a piece of information. As such, an overall narrative or body of information may, according to some embodiments of the invention, be decomposed into individual elements at whatever level of granularity a user finds appropriate in a given case. The objective in such an embodiment is to carve the overall narrative or body such that each piece of information represents a single, discreet element of the narrative or body that can be individually revealed, independent of any other piece of information. The examples used in the various figures reflect this approach, as each piece of information represents a single basic building block of the overall narrative.

By carving the information up in this way, the process of revealing a piece of information becomes more straightforward and intuitive. A user can reveal a given piece of information with a single operation, such as a single click of the mouse. This makes it possible to easily reveal content from a database in real-time, in parallel with the broadcast of a television show or other similar event, thus providing fans of the show a real-time feed of the information as it is disclosed within the show itself. Such a real-time feed may take the form of, for example, an RSS feed, a Twitter feed, a blog posting, a Facebook posting, etc. Other real-time feeds will be apparent to one of ordinary skill in the art and are within the scope of the invention.

Once the information is carved up into elements of the overall narrative at the requisite level of granularity, the individual pieces can be revealed in virtually any order, with the experience of the revelation being entirely different based purely upon the order in which the pieces are revealed. No change to the underlying database content is necessitated to yield a potentially completely different experience for the person to whom the information is revealed. This approach is of great importance in a variety of applications, such as role-playing games, computer games, and “choose your own adventure” style books.

According to the various embodiments of the invention, relationships between and among pieces of information may be established in any number of ways. For example, a user may manually link two or more pieces of information based upon the user's knowledge of the pieces of information and/or a larger work of which they form a part. In other embodiments of the invention, pieces of information may be automatically linked and a relationship established based on their having text or some other component(s) in common. Such links may be automatically detected using known searching and filtering methods.

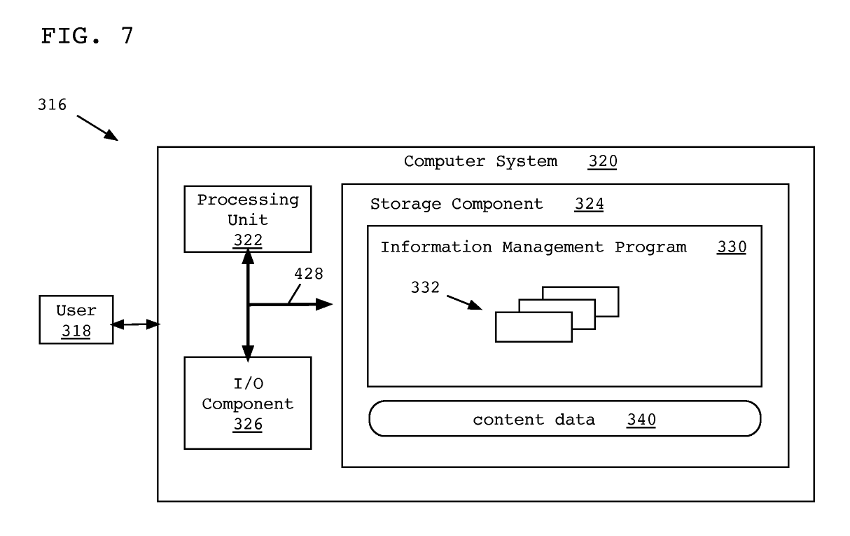

FIG. 7 shows an illustrative environment 316 for managing information according to an embodiment of the invention. Environment 316 includes a computer system 320 that can perform a process described herein in order to manage information, including the incremental release of information. In particular, computer system 320 is shown including an information management program 330, which makes computer system 320 operable to manage information by performing a process described herein.

Computer system 320 is shown including a processing component 322 (e.g., one or more processors), a storage component 324 (e.g., a storage hierarchy), an input/output (I/O) component 326 (e.g., one or more I/O interfaces and/or devices), and a communications pathway 328. In general, processing component 322 executes program code, such as information management program 330, which is at least partially fixed in storage component 324. While executing program code, processing component 322 can process data, which can result in reading and/or writing transformed data from/to storage component 324 and/or I/O component 326 for further processing. Pathway 328 provides a communications link between each of the components in computer system 320. I/O component 326 can comprise one or more human I/O devices, which enable a human user 318 to interact with computer system 320 and/or one or more communications devices to enable a system user 318 to communicate with computer system 320 using any type of communications link. To this extent, information management program 330 can manage a set of interfaces (e.g., graphical user interface(s), application program interface, and/or the like) that enable human and/or system users 318 to interact with information management program 330. Further, information management program 330 can manage (e.g., store, retrieve, create, manipulate, organize, present, etc.) the data, such as content data 340, using any solution.

In any event, computer system 320 can comprise one or more general purpose computing articles of manufacture (e.g., computing devices) capable of executing program code, such as information management program 330, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, information management program 330 can be embodied as any combination of system software and/or application software.

Further, information management program 330 can be implemented using a set of modules 332. In this case, a module 332 can enable computer system 320 to perform a set of tasks used by information management program 330, and can be separately developed and/or implemented apart from other portions of information management program 330. As used herein, the term “component” means any configuration of hardware, with or without software, which implements the actions described in conjunction therewith using any solution, while the term “module” means program code that enables a computer system 320, such as a general purpose computing device, to implement the actions described in conjunction therewith using any solution. When fixed in a storage component 324 of a computer system 320 that includes a processing component 322, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 320.

When computer system 320 comprises multiple computing devices, each computing device can have only a portion of information management program 330 fixed thereon (e.g., one or more modules 332). However, it is understood that computer system 320 and information management program 330 are only representative of various possible equivalent computer systems that may perform a process described herein. To this extent, in other embodiments, the functionality provided by computer system 320 and information management program 330 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 320 includes multiple computing devices, the computing devices can communicate over any type of communications link. Further, while performing a process described herein, computer system 320 can communicate with one or more other computer systems, such as a system user 318, using any type of communications link. In either case, the communications link can comprise any combination of various types of wired and/or wireless links; comprise any combination of one or more types of networks; and/or utilize any combination of various types of transmission techniques and protocols.

As discussed herein, information management program 330 enables computer system 320 to manage information, including the incremental release of information. To this extent, information management program 330 is configured to enable computer system 320 to manage content data 340, which computer system 320 can process to manage the content of a project. In an embodiment, content data 340 comprises a set of data representing discrete components available for use in the creation of a project.

In another embodiment, the invention provides a method that performs the process steps of the invention on a subscription, advertising, and/or fee basis. That is, a service provider could offer to manage information, as described above. In this case, the service provider can create, maintain, support, etc., a computer infrastructure, such as computer system 320, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for managing information, including the incremental release of information. In this case, a computer infrastructure, such as computer system 320, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 320, from a computer-readable medium; (2) adding one or more computer systems to the computer infrastructure; and (3) incorporating and/or modifying one or more existing systems of the computer infrastructure, to enable the computer infrastructure to perform the process steps of the invention.

The terminology used herein is for the purpose of describing particular embodiments only and is not intended to be limiting of the disclosure. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of incrementally disclosing information from a restricted database of information, the method comprising:
accessing a restricted database of information containing:
a first piece of information; and
a second piece of information related to the first piece of information;
releasing from the restricted database the first piece of information; and
releasing from the restricted database the second piece of information consistent with the relationship between the second piece of information and the first piece of information.

2. The method of claim 1, further comprising:
defining the relationship between the second piece of information and the first piece of information.

3. The method of claim 2, wherein defining the relationship includes defining a temporal relationship between the second piece of information and the first piece of information.

4. The method of claim 2, wherein defining the relationship includes defining a logical relationship between the second piece of information and the first piece of information.

5. The method of claim 1, further comprising:
receiving an indication that a proposed release of the second piece of information is not consistent with the relationship between the second piece of information and the first piece of information.

6. The method of claim 1, further comprising:
deriving the first piece of information and the second piece of information from a larger work.

7. The method of claim 6, wherein the larger work is contained within the restricted database.

8. The method of claim 6, further comprising:
adding the first piece of information and the second piece of information to the restricted database.

9. The method of claim 6, wherein deriving the first piece of information and the second piece of information from a larger work includes:
decomposing an undifferentiated larger work into a plurality of discrete pieces of information within the restricted database,
wherein the plurality of discrete pieces of information includes the first piece of information and the second piece of information.

10. The method of claim 1, wherein the second piece of information is released before the first piece of information is released.

11. A system comprising:
at least one computing device configured for incrementally disclosing information from a restricted database of information by performing a method comprising:
accessing a restricted database of information containing:
a first piece of information; and
a second piece of information related to the first piece of information;
releasing from the restricted database the first piece of information; and
releasing from the restricted database the second piece of information consistent with the relationship between the second piece of information and the first piece of information.

12. The system of claim 11, wherein the method further comprises:
defining the relationship between the second piece of information and the first piece of information.

13. The system of claim 12, wherein defining the relationship between the second piece of information and the first piece of information includes defining at least one of a temporal relationship or a logical relationship between the second piece of information and the first piece of information.

14. The system of claim 11, wherein the method further comprises:
deriving the first piece of information and the second piece of information from a larger work within the restricted database.

15. The system of claim 14, wherein the method further comprises:
adding the first piece of information and the second piece of information to the restricted database.

16. A program product stored on a computer-readable storage medium which, when executed, is operable to incrementally disclose information from a restricted database of information by performing a method comprising:
accessing a restricted database of information containing:
a first piece of information; and
a second piece of information related to the first piece of information;
releasing from the restricted database the first piece of information; and
releasing from the restricted database the second piece of information consistent with the relationship between the second piece of information and the first piece of information.

17. The program product of claim 16, wherein the method further comprises:
defining the relationship between the second piece of information and the first piece of information.

18. The program product of claim 17, wherein defining the relationship between the second piece of information and the first piece of information includes defining at least one of a temporal relationship or a logical relationship between the second piece of information and the first piece of information.

19. The program product of claim 16, wherein the method further comprises:
deriving the first piece of information and the second piece of information from a larger work within the restricted database.

20. The program product of claim 19, wherein the method further comprises:
adding the first piece of information and the second piece of information to the restricted database.

21. A method of managing information, the method comprising:
accessing a work containing a plurality of pieces of information;
deriving from the work a first piece of information and a second piece of information;
defining a relationship between the first piece of information and the second piece of information,
whereby use of either or both of the first piece of information and the second piece of information is consistent with the defined relationship between the first piece of information and the second piece of information.
